(19) United States
(12) Patent Application Publication
(10) Pub. No.: US 2021/0197562 A1
(43) Pub. Date: Jul. 1, 2021

(54) LIQUID DISCHARGE HEAD, RECORDING DEVICE, AND RECOVERY METHOD

(71) Applicant: CANON KABUSHIKI KAISHA, Tokyo (JP)

(72) Inventors: Kyosuke Toda, Kanagawa (JP); Sayaka Seki, Kanagawa (JP); Shimpei Yoshikawa, Kanagawa (JP); Kazuhiko Okito, Kanagawa (JP); Kenji Yabe, Kanagawa (JP); Yasuaki Kitayama, Kanagawa (JP); Ryo Sato, Tokyo (JP)

(21) Appl. No.: 17/119,901

(22) Filed: Dec. 11, 2020

(30) Foreign Application Priority Data
Dec. 25, 2019 (JP) 2019-234622

(51) Int. Cl. B41J 2/14; B41J 2/165

(52) U.S. Cl. CPC B41J 2/14; B41J 2/165

(57) ABSTRACT

A liquid discharge head includes an element substrate including an energy generation element configured to generate energy for discharging liquid from a discharge port, and a supporting member which supports the element substrate and in which a liquid chamber configured to supply liquid to the discharge port is formed, wherein a recessed portion communicating with the liquid chamber is formed at a position above the liquid chamber in a vertical direction in an orientation of the liquid discharge head when used, and wherein at least one of surfaces forming the recessed portion is formed of a flexible member configured to absorb vibration of liquid in the liquid chamber.

### BACKGROUND

### Field of the Disclosure

The present disclosure relates to a liquid discharge head, a recording device, and a recovery method.

### Description of the Related Art

A liquid discharge head using a method to form a photograph, a document, or a three-dimensional structure discharges a plurality of types of liquids such as inks onto a recording medium. In a case where multiple nozzles are formed or the interval of discharging liquid is shortened for achieving high-speed recording, the vibration of liquid inside a liquid chamber that supplies liquid to a discharge port is likely to become large. If the liquid is discharged before the vibration of the liquid is sufficiently ceased, the recording quality may possibly be adversely affected.

A liquid discharge head discussed in Japanese Patent No. 6349763 has a configuration in which, to restrain the vibration of liquid inside a liquid chamber, a member having flexibility (a damper) is provided in a part of a wall surface of the liquid chamber.

In the liquid discharge head discussed in Japanese Patent No. 6349763, a space where air bubbles, generated in the liquid chamber, can be accommodated is not formed. Thus, the air bubbles generated in the liquid chamber may enter a discharge port with the flow of liquid, and it may be difficult to discharge liquid from the discharge port.

### SUMMARY

Aspects of the present disclosure provide a liquid discharge head capable of restraining the vibration of liquid inside a liquid chamber and also preventing air bubbles generated in the liquid chamber from entering a discharge port.

According to an aspect of the present disclosure, a liquid discharge head includes an element substrate including an energy generation element configured to generate energy for discharging liquid from a discharge port, and a supporting member which supports the element substrate and in which a liquid chamber configured to supply liquid to the discharge port is formed, wherein a recessed portion communicating with the liquid chamber is formed at a position above the liquid chamber in a vertical direction in an orientation of the liquid discharge head when used, and wherein at least one of surfaces forming the recessed portion is formed of a flexible member configured to absorb vibration of liquid in the liquid chamber.

Further features of the present disclosure will become apparent from the following description of exemplary embodiments with reference to the attached drawings.

### BRIEF DESCRIPTION OF THE DRAWINGS

FIG. 1A is an exploded perspective view of a liquid discharge head, and FIG. 1B is a partial cross-sectional view of an internal configuration in a vicinity of a discharge port.

FIG. 2 is a front view of the liquid discharge head.

FIG. 3 is a cross-sectional view along an A-A cross section illustrated in FIG. 2.

FIG. 4 is a cross-sectional view along a B-B cross section illustrated in FIG. 3.

FIG. 5 is a schematic diagram illustrating a filter and air bubbles.

FIGS. 6A, 6B, 6C and 6D are cross-sectional views illustrating a liquid discharge head according to a second exemplary embodiment.

FIG. 7 is a perspective view illustrating a sealing member according to the second exemplary embodiment.

FIGS. 8A, 8B and 8C are schematic diagrams illustrating variations of flexible members according to the second exemplary embodiment.

FIGS. 9A and 9B are cross-sectional views illustrating a liquid discharge head according to a third exemplary embodiment.

FIGS. 10A and 10B are schematic diagrams illustrating a flow path member.

FIG. 11 is a diagram illustrating a flowchart illustrating a suction recovery process.

### DESCRIPTION OF THE EMBODIMENTS

### First Exemplary Embodiment

### (Liquid Discharge Head)

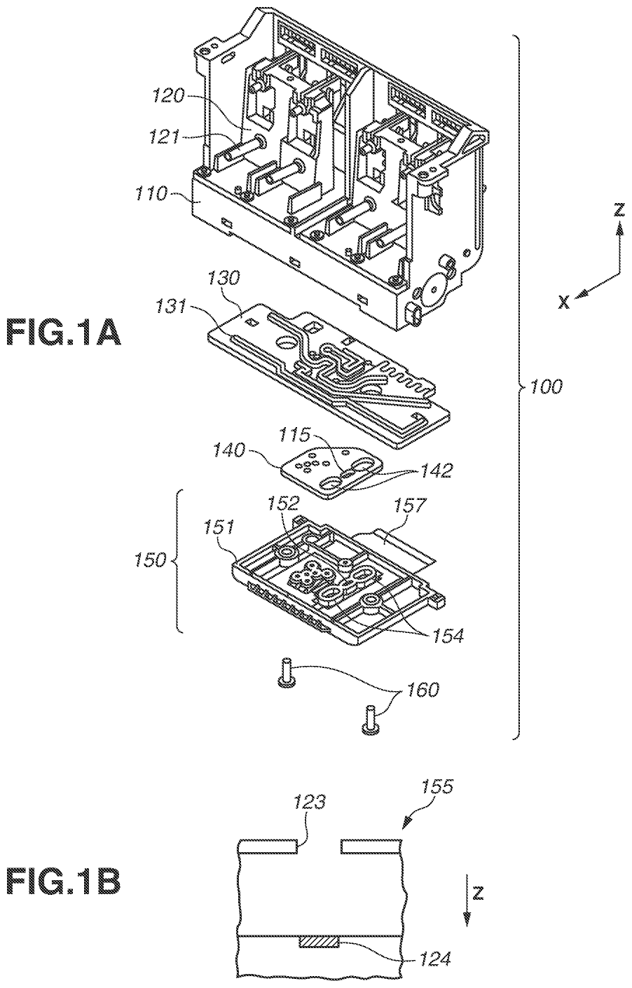

FIG. 1A is an exploded perspective view illustrating a liquid discharge head 100 according to the present exemplary embodiment. The liquid discharge head 100 mainly includes a sub-tank 120, a housing 110, a flow path member 130 and a recording element unit 150. These members are fixed to each other with screws 160. The sub-tank 120 is a tank that stores, in the liquid discharge head 100, liquid supplied from a main tank (not illustrated) that stores liquid (ink). The flow path member 130 includes a flow path 131 for supplying liquid supplied from the sub-tank 120 to an element substrate 155 (FIG. 1B). The recording element unit 150 includes the element substrate 155 that discharges liquid, a supporting member 151 that supports the element substrate 155, and a flexible substrate 157 electrically connected to the element substrate 155. The supporting member 151 is in contact with the element substrate 155 via an adhesive (not illustrated).

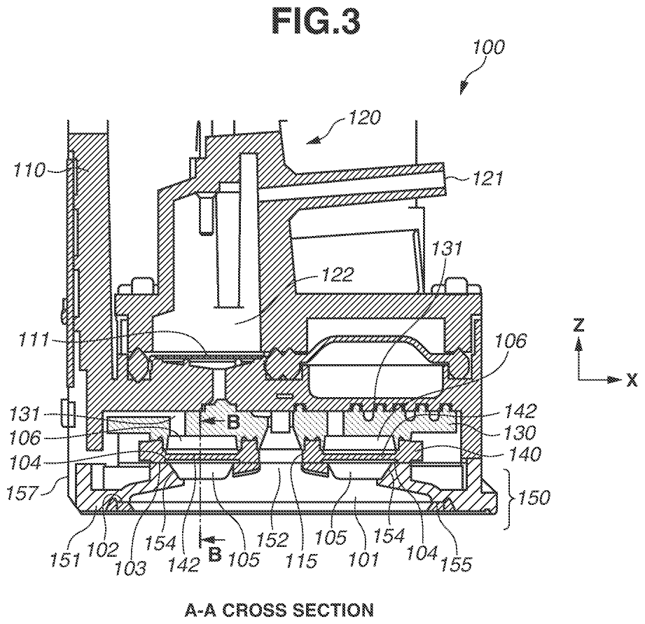

Between the flow path member 130 and the recording element unit 150, a sealing member 140 is disposed. The sealing member 140 includes flexible members 142 that absorb the vibration of liquid generated under the influence of pressure occurring when liquid is discharged, and a sealing portion 115 that prevents liquid from leaking to outside. The flexible members 142 are each composed of a member having flexibility. As described in detail below, the provision of the flexible members 142 can restrain the vibration of liquid in a liquid chamber 101. Further, the flexible members 142 are formed to close openings of through-holes 154 formed in the supporting member 151, thereby forming recessed portions 105 (FIG. 3). The sealing portion 115 is composed of a member having flexibility and prevents liquid from leaking to outside from a portion between the flow path member 130 and the recording element unit 150. A portion other than the flexible members 142 and the sealing portion 115 of the sealing member 140 is mainly formed of a resin. Thus, the sealing member 140 is composed of members having flexibility and a resin member.

FIG. 1B is a partial cross-sectional view illustrating the internal configuration of the vicinity of a discharge port 123 of the element substrate 155. As illustrated in FIG. 1B, an energy generation element 124 that generates energy for discharging liquid from the discharge port 123 is formed in the element substrate 155. Liquid is film-boiled by driving the energy generation element 124 and discharged from the discharge port 123.

### (Internal Configuration of Liquid Discharge Head)

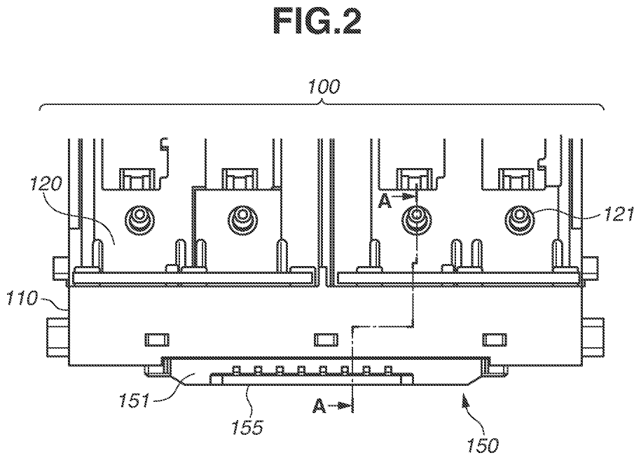

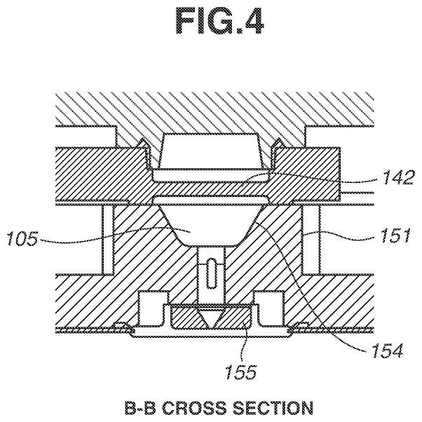

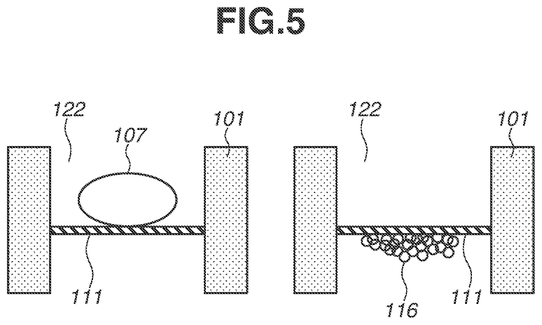

FIG. 2 is a partial front view of the liquid discharge head 100 illustrated in FIGS. 1A and 1B in a completed state. FIG. 3 is a cross-sectional view along an A-A cross section illustrated in FIG. 2. FIG. 4 is a cross-sectional view along a B-B cross section illustrated in FIG. 3. As illustrated in FIG. 3, the sub-tank 120 includes a liquid connection portion 121 and a liquid storage portion 122 that stores liquid. A tube (not illustrated) is connected to the liquid connection portion 121, and liquid from the main tank is supplied to the liquid storage portion 122. The liquid stored in the liquid storage portion 122 flows through the flow path member 130, the sealing portion 115 of the sealing member 140, a supply port 152 of the supporting member 151 and the liquid chamber 101 in this order and is then supplied to the discharge port 123. At this time, when the liquid flows from the liquid storage portion 122 to the flow path member 130, the liquid passes through a filter 111 that collects a foreign substance in the liquid. Air bubbles that enter the liquid chamber 101 are generated by, for example, as illustrated in FIG. 5, a mass of air 107 passing through the filter 111 and becoming minute air bubbles when the liquid is suctioned from the discharge port 123.

At positions in the supporting member 151 that are opposed to the element substrate 155, the through-holes 154 are formed. On a second surface 103 that is the back surface of a first surface 102 of the supporting member 151 that supports the element substrate 155, the sealing member 140 is placed. The flexible members 142 of the sealing member 140 are arranged to cover openings 104 of the through-holes 154.

The flexible members 142 are placed to cover the openings 104 of the through-holes 154 formed in the supporting member 151, thereby forming the recessed portions 105 at positions in the supporting member 151 that are opposed to the element substrate 155. That is, the recessed portions 105 are provided above the element substrate 155 in the vertical direction in the orientation of the liquid discharge head 100 when used. In a normal state where recording is performed, the liquid chamber 101 and the recessed portions 105 are filled with liquid.

For example, when liquid near the liquid chamber 101 thickens, and it is difficult to discharge liquid from the discharge port 123, liquid in the discharge port 123 and the liquid chamber 101 may be removed to recover the discharge performance. If a suction operation for suctioning liquid from the discharge port 123 is performed to remove the liquid, then as illustrated in FIG. 5, the mass of air 107 having passed through the filter 111 disposed upstream of the liquid chamber 101 may become minute and become air bubbles 116. Then, the air bubbles 116 may enter the liquid chamber 101. If air bubbles are present in the liquid chamber 101, the air bubbles may enter the discharge port 123 with the flow of liquid and may make it difficult to discharge liquid from the discharge port 123. To solve this issue, the recessed portions 105 are provided in the supporting member 151 to communicate with the liquid chamber 101, whereby it is possible to keep air bubbles generated in the liquid chamber 101 in the recessed portions 105. Consequently, even if air bubbles are generated in the liquid chamber 101, the air bubbles are kept in the recessed portions 105, thereby preventing the air bubbles from entering the discharge port 123. Thus, it is possible to avoid the state where it is difficult to discharge liquid.

Even if liquid vibrates in the discharge port 123 and the liquid chamber 101, the flexible members 142 that are provided at positions opposed to the element substrate 155 deform in response to the vibration of the liquid. This can quickly reduce the vibration of the liquid. In FIG. 3, each flexible member 142 is formed on an upper surface of the recessed portion 105. The present exemplary embodiment, however, is not limited to this. That is, the flexible member 142 may be formed on at least one of surfaces forming the recessed portion 105. With such a configuration, the effect of absorbing the vibration of liquid can also be obtained. The back surface (a space portion 106) of a surface on the recessed portion side of the flexible member 142 is communicated with atmosphere, thereby facilitating the deformation of the flexible member 142.

Due to the configuration where the flexible member 142 forms a part of a wall surface of the recessed portion 105, it is easy to discharge air bubbles kept in the recessed portion 105 to outside when the suction operation for suctioning liquid from the discharge port 123 is performed next. This is because the flexible member 142 bends to protrude to the element substrate 155 side due to negative pressure when the suction operation is performed, and thus the air bubbles are pushed out to the liquid chamber 101 by the flexible member 142 and eventually discharged from the discharge port 123 to outside. Thus, when the suction operation is performed, air bubbles kept in the recessed portion 105 are positively discharged from the discharge port 123 to outside, and air bubbles that are not discharged from the discharge port 123 are kept in the recessed portion 105, whereby it is possible to prevent air bubbles from being present in the discharge port 123 when a recording operation is performed.

It is desirable that the cross-sectional shape of the liquid chamber 101 be such a shape that the liquid chamber 101 gradually enlarges from the supply port 152 to the element substrate 155 as illustrated in FIG. 3. That is, it is desirable that surfaces of the liquid chamber 101 that serve as ceilings when the liquid discharge head 100 is used are slopes. Due to the foregoing configuration of the liquid chamber 101, air bubbles generated in the liquid chamber 101 are likely to move upward in the vertical direction along the ceilings having the slopes when the liquid discharge head 100 is used. Thus, it is easy to collect air bubbles in the recessed portions 105 formed in the middle of the slopes.

On the opposite side of the surfaces of the flexible members 142 facing the recessed portions 105, the space portions 106 are formed. The formation of the space portions 106 facilitates the deformation of the flexible members 142. Consequently, the flexible members 142 can excellently restrain the vibration of liquid.

Further, due to the temporary discharge of a large amount of liquid from the discharge port 123, the supply of liquid from the supply port 152 to the liquid chamber 101 may not be sufficient. In this case, the inside of the liquid chamber 101 rapidly enters a depressurized state. Accordingly, the flexible members 142 deform to protrude to the liquid chamber 101 side, so that liquid stored in the recessed portions 105 is pushed out to the liquid chamber 101 due to the deformation of the flexible members 142. Thus, it is possible to prevent the state where the supply of liquid is insufficient. To sufficiently exert this effect, the flexible members 142 need to greatly deform in response to a change in pressure in the liquid chamber 101 and have quick deformation responsiveness. Thus, it is desirable that the flexible members 142 be thinly formed. If, however, the flexible members 142 are thin, water vapor is likely to pass through the flexible members 142, and a change in tint may occur due to a change in the concentration of liquid. Thus, it is desirable that as the flexible members 142, hydrogenated nitrile rubber (HNBR) or chlorinated butyl rubber (CIIR), which has low permeability to water vapor, is used.

### (Atmosphere Communication Path)

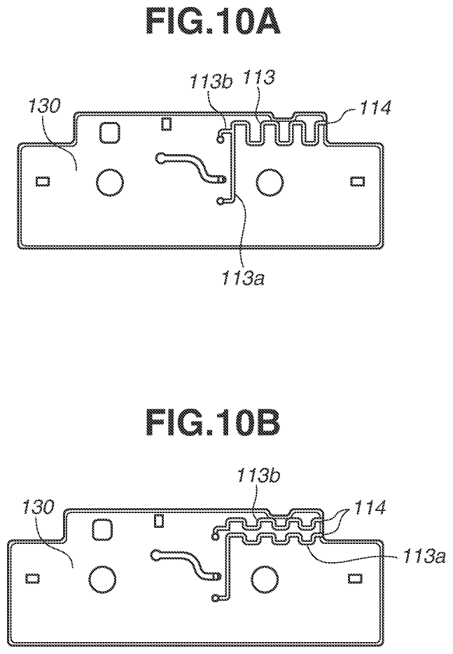

FIG. 10A is a diagram illustrating a top view of the flow path member 130. FIG. 10B is a diagram illustrating a variation of the flow path member 130 illustrated in FIG. 10A. In the flow path member 130, an atmosphere communication path 113 communicating with atmosphere is formed. In FIGS. 10A and 10B, two atmosphere communication paths, i.e., a first atmosphere communication path 113a and a second atmosphere communication path 113b, are formed. The first atmosphere communication path 113a is an atmosphere communication path connected to the space portion 106 (a first space portion) on the recessed portion (a first recessed portion) side on the back surface side of the flexible member 142 (a first flexible member) which is one of the two flexible members 142 illustrated on the right side of FIG. 3. The second atmosphere communication path 113b is an atmosphere communication path connected to the space portion 106 (a second space portion) on the recessed portion (a second recessed portion) side on the back surface side of the flexible member 142 (a second flexible member) which is the other one of the two flexible members 142 illustrated on the left side of FIG. 3. That is, the space portions 106 on the back surface sides of the flexible members 142 are open to atmosphere through the atmosphere communication path 113. Thus, a volatile component in liquid in the liquid chamber 101 gradually evaporates through the atmosphere communication path 113. The amount of evaporation of the liquid has a relationship where the greater the cross-sectional area of the atmosphere communication path 113 is, the greater the amount of evaporation is, and the greater the length of the atmosphere communication path 113 is, the smaller the amount of evaporation is. Accordingly, in order to reduce the amount of evaporation of liquid, the atmosphere communication path 113 is bent multiple times to increase the length of the atmosphere communication path 113. In FIG. 10A, the first atmosphere communication path 113a and the second atmosphere communication path 113b join together in the middle (between an end portion on the first recessed portion side and an end portion on the opposite side of the first atmosphere communication path 113a). This can form a long atmosphere communication path 113 in a small region.

The first atmosphere communication path 113a and the second atmosphere communication path 113b may be independently formed as illustrated in FIG. 10B. With the configuration as illustrated in FIG. 10B, it is possible to prevent a change in pressure in one of the space portions 106 (the first space portion) from influencing pressure in the other space portion 106 (the second space portion), and the flexible members 142 can stably restrain the vibration of liquid.

### Second Exemplary Embodiment

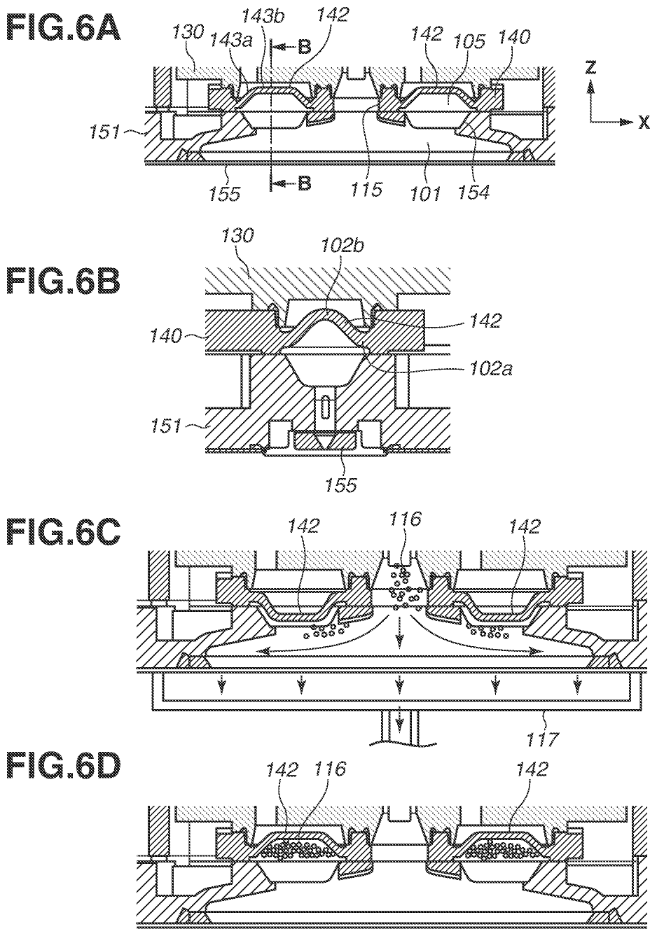

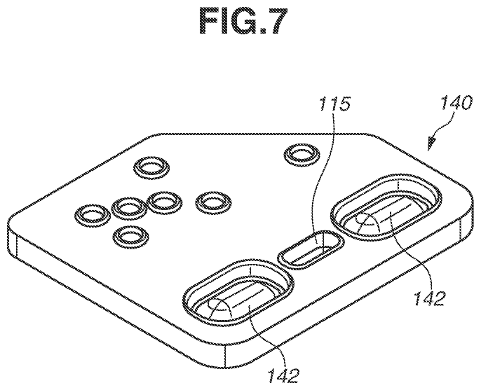

Portions similar to those in the first exemplary embodiment are designated by the same reference numerals, and are not described. FIG. 6A is a cross-sectional view of the liquid discharge head 100 according to a second exemplary embodiment corresponding to the A-A cross section illustrated in FIG. 2. FIG. 6B is a cross-sectional view along a B-B cross section illustrated in FIG. 6A. FIG. 6C is a diagram illustrating the state where the suction operation for suctioning liquid from the discharge port 123 is performed using a cap member 117 (a suction unit) included in a recording device (not illustrated). FIG. 6D is a diagram illustrating the state after the suction operation is performed using the cap member 117. FIG. 7 is a perspective view illustrating the sealing member 140. As illustrated in FIGS. 6A, 6C, 6D and 7, the flexible members 142 according to the present exemplary embodiment have shapes protruding upward in the vertical direction (hereinafter referred to as “protruding upward”) in the orientation of the liquid discharge head 100 when used. Consequently, regions where air bubbles can be kept become large, and even if many air bubbles are generated in the liquid chamber 101, it is possible to prevent the air bubbles from entering the discharge port 123.

When liquid is suctioned from the discharge port 123, as illustrated in FIG. 6C, the shapes of the flexible members 142 protruding upward invert due to negative pressure generated by the cap member (suction member) 117 so that the shapes protrude downward in the vertical direction (hereinafter referred to as “protrude downward”). Consequently, regions in the recessed portions 105 decrease when the liquid is suctioned, and thus it is possible to prevent air bubbles from being kept in the recessed portions 105 when the liquid is suctioned. If the suction ends, the flexible members 142 restore the original shapes protruding upward. This is because each flexible member 142 has different thicknesses in a root portion 143a and an upper surface 143b, and the root portion 143a is thicker than the upper surface 142b. If the root portion 143a is made thick, the flexible member 142 is biased to have a shape protruding upward in the vertical direction. The thickness of the root portion 143a is the average value of thicknesses at ten points randomly selected from two sections at both ends among three sections into which the entire length (the length in an X-direction) of the flexible member 142 is divided. The thickness of the upper surface 142b is the average value of thicknesses at five points randomly selected from the middle section among the three sections. With the configuration of the flexible member 142 having different thicknesses at different places, even in a case where the protruding shape inverts and protrudes to the element substrate side when the suction operation is performed, the flexible member 142 automatically restores the original shape protruding upward in the vertical direction when the suction operation ends. Thus, similarly to the first exemplary embodiment, air bubbles that are not discharged to outside can be held in the recessed portions 105.

Each flexible member 142 illustrated in FIGS. 6A to 6D and 7 has a shape fitting the shape of the recessed portion 105 when the flexible member 142 inverts. Consequently, when the flexible member 142 inverts by the suction operation for suctioning liquid from the discharge port 123, a gap formed between the through-hole 154 and the flexible member 142 forming the recessed portion 105 becomes small. Thus, it is possible to discharge more air bubbles from the recessed portion 105.

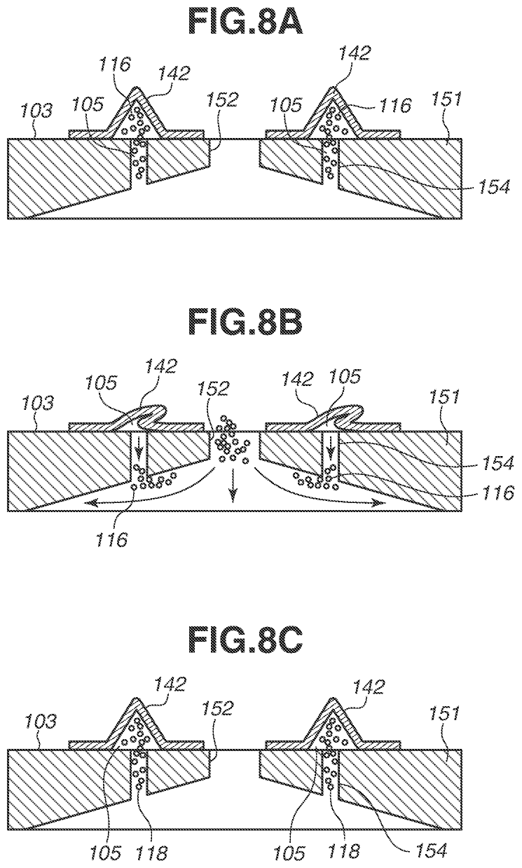

FIGS. 8A to 8C illustrate variations of the flexible members 142 illustrated in FIGS. 6A to 6D and 7. FIG. 8A is a schematic diagram illustrating the state where air bubbles have entered the liquid chamber 101 by suctioning liquid from the cap member 117, and air bubbles 116 are accumulated in the recessed portions 105. FIG. 8B is a schematic diagram illustrating the state in the middle of suctioning liquid in the liquid chamber 101 using the cap member 117, which has changed from the state illustrated in FIG. 8A. FIG. 8C is a schematic diagram illustrating the state where a certain time has elapsed after the end of suctioning liquid from the cap member 117.

As illustrated in FIG. 8B, the flexible members 142 according to the present exemplary embodiment do not need to have such a shape that inverts as illustrated in FIG. 6C when liquid is suctioned from the discharge port 123. With shapes as illustrated in FIGS. 8A to 8C, the flexible members 142 deform to decrease regions in the recessed portions 105 when liquid is suctioned from the discharge port 123 (FIG. 8B). Thus, if the suction operation for discharging liquid inside the liquid chamber 101 to outside is performed in the state where air bubbles are accumulated inside the recessed portions 105 (FIG. 8A), as illustrated in FIG. 8B, the flexible members 142 can push out the air bubbles in the recessed portions 105 to the liquid chamber side and then discharge the air bubbles to outside. Consequently, immediately after the suction operation ends, few air bubbles are present inside the recessed portions 105, and the inside of the recessed portions 105 is filled with liquid.

At this time, regions in the recessed portions 105, where air bubbles can be held, are remaining regions where air bubbles are not present. Thus, in a case where new air bubbles are generated in the liquid chamber 101, regions in the recessed portions 105 where the new air bubbles can be held are very small regions before the suction operation is performed (FIG. 8A). On the other hand, immediately after the suction operation is performed, few air bubbles are present in the recessed portions 105, and therefore, more air bubbles can be newly held. Thus, even if new air bubbles are generated in the liquid chamber 101 with the lapse of time, new air bubbles 118 can be held in the recessed portions 105 without causing the new air bubbles 118 to flow out of the recessed portions 105 (FIG. 8C). That is, it is possible to prevent air bubbles from overflowing from the recessed portions 105 and being present in the liquid chamber 101. If some air bubbles are accumulated again in the recessed portions 105 after the suction operation is performed as illustrated in FIG. 8C, the suction operation for suctioning liquid in the liquid chamber 101 is performed using the cap member 117 again. Consequently, it is possible to discharge the air bubbles to outside again and hold new air bubbles in the recessed portions 105. Air bubbles are newly generated in the liquid chamber 101, for example, due to the fact that some air bubbles obtained by the energy generation element 124 film-boiling liquid move to the liquid chamber side, or air passes through the supporting member 151 and enters the liquid chamber 101. The description with reference to FIGS. 8A to 8C is not limited to the present exemplary embodiment, and the same applies to the flexible members 142 according to the first exemplary embodiment.

### (Suction Recovery)

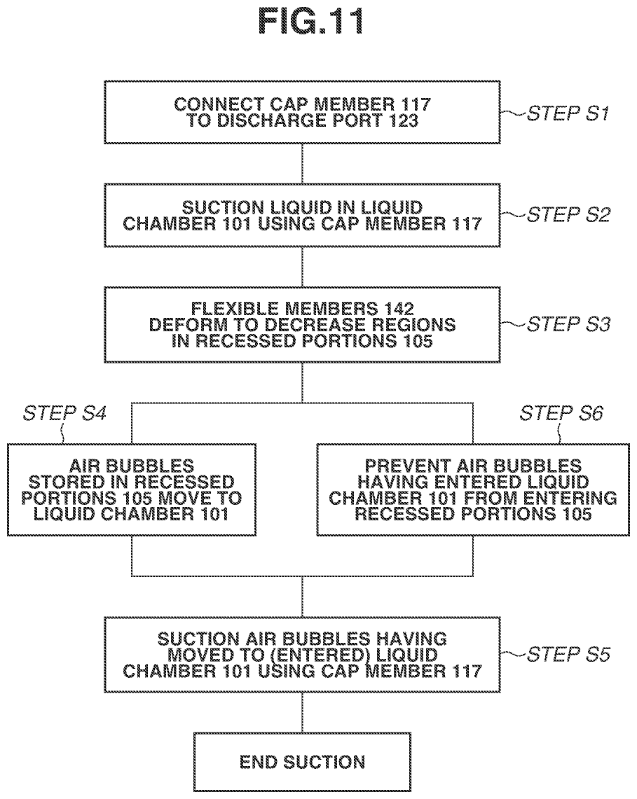

Next, with reference to FIG. 11, a description is given of a recovery method for, when the discharge performance of discharging liquid from the discharge port 123 decreases, recovering the discharge performance (suction recovery). FIG. 11 is a flowchart illustrating steps of the recovery method for recovering the discharge performance. First, in step S1, the cap member 117 (see FIG. 6C) is connected to the discharge port 123. Next, in step S2, liquid in the liquid chamber 101 is suctioned using the cap member 117. At this time, the inside of the liquid chamber 101 has negative pressure. Due to the negative pressure, then in step S3, the flexible members 142 deform (protrude downward) to decrease regions in the recessed portions 105 as illustrated in FIG. 6C. In step S4, air bubbles stored in the recessed portions 105 are thus pushed out to the liquid chamber side by the flexible members 142. Since the air bubbles are pushed out to the liquid chamber 101, then in step S5, it is easy to remove air bubbles from the cap member 117. Even if air bubbles are not present in the recessed portions 105 before the suction operation, the deformation of the flexible members 142 to the liquid chamber side when the suction operation is performed has an effect. That is, when the flexible members 142 deform to the liquid chamber side, the recessed portions 105 are in a closed state. Thus, in step S6, it is possible to prevent air bubbles entering the liquid chamber 101 from upstream from entering the recessed portions 105. Thus, air bubbles are not substantially present in the recessed portions 105 during the suction operation and immediately after the suction operation ends. Consequently, even if air bubbles gradually enter the liquid chamber 101 after the suction operation ends, the air bubbles can be held in the entire regions inside the recessed portions 105. This allows more air bubbles to be held therein, so that it is possible to prevent air bubbles held in the recessed portions 105 from flowing out to the liquid chamber side and reaching the discharge port 123.

### Third Exemplary Embodiment

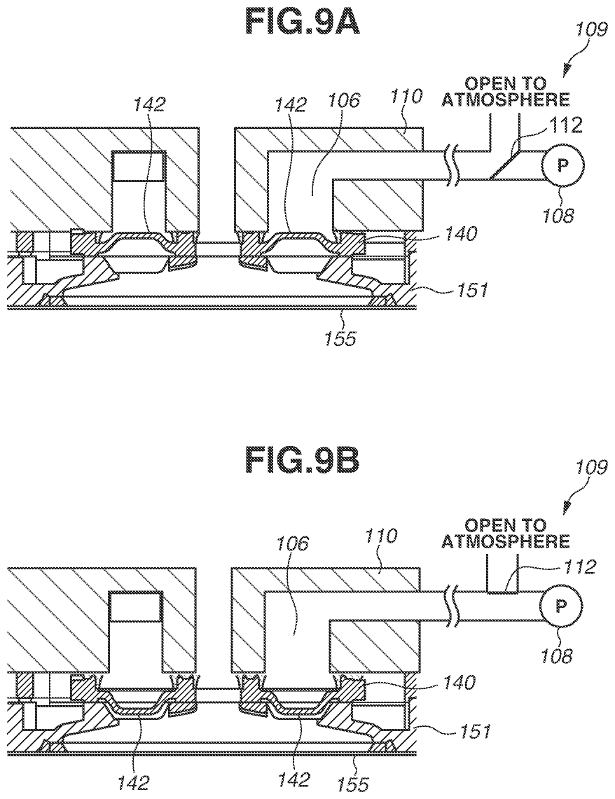

Portions similar to those in the first exemplary embodiment are designated by the same reference numerals, and are not described. The present exemplary embodiment is characterized in that a pressurization pump is provided to communicate with the space portions 106. Consequently, without performing the above suction operation, it is possible to deform the flexible members 142 to the liquid chamber side by driving the pressurization pump. FIG. 9A is a diagram illustrating the state where a pressurization pump 108 is provided in the recording device to communicate with the back surface sides of the flexible members 142, and the back surface sides of the flexible members 142 are open to atmosphere. FIG. 9B is a diagram illustrating the state where the pressurization pump 108 is provided in the recording device to communicate with the back surfaces of the flexible members 142, and the back surface sides (the back surface sides of surfaces facing the element substrate 155) of the flexible members 142 are pressurized by the pressurization pump 108.

The back surface sides of the flexible members 142 are open to atmosphere in a normal state (when recording is performed). When a recovery operation of the liquid discharge head 100 is performed, however, the back surface sides of the flexible members 142 are connected to a path leading to the pressurization pump 108 by the operation of a switch valve 112. Then, the back surface sides are pressurized by the pressurization pump 108, whereby it is possible to invert the shapes of the flexible members 142 protruding upward (i.e., cause the flexible members 142 protruding upward to protrude downward). Consequently, it is possible to invert the flexible members 142 at a desired timing. Thus, it is possible to efficiently discharge air bubbles held in the recessed portions 105.

According to the exemplary embodiments of the present disclosure, it is possible to suppress the vibration of liquid inside a liquid chamber and also prevent air bubbles generated in the liquid chamber from entering a discharge port.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2019-234622, filed Dec. 25, 2019, which is hereby incorporated by reference herein in its entirety.

What is claimed is:

1. A liquid discharge head comprising:
an element substrate including an energy generation element configured to generate energy for discharging liquid from a discharge port; and
a supporting member which supports the element substrate and in which a liquid chamber configured to supply liquid to the discharge port is formed,
wherein a recessed portion communicating with the liquid chamber is formed at a position above the liquid chamber in a vertical direction in an orientation of the liquid discharge head when used, and
wherein at least one of surfaces forming the recessed portion is formed of a flexible member configured to absorb vibration of liquid in the liquid chamber.

2. The liquid discharge head according to claim 1, wherein the flexible member is formed on an upper surface of the recessed portion in the orientation.

3. The liquid discharge head according to claim 1,
wherein a through-hole communicating with the liquid chamber is formed in the supporting member, and
wherein the recessed portion is formed by the flexible member being disposed across an opening of the through-hole.

4. The liquid discharge head according to claim 1, wherein a space portion is formed by a back surface of the flexible member of a surface on the recessed portion side of the flexible member.

5. The liquid discharge head according to claim 1, further comprising:
a flow path member including a flow path for supplying liquid to the liquid chamber; and
a sealing member disposed between the flow path member and the supporting member and connecting the flow path to the liquid chamber while sealing the flow path and the liquid chamber,
wherein the flexible member is formed in the sealing member.

6. The liquid discharge head according to claim 5, wherein the sealing member includes a resin portion and a flexible portion.

7. The liquid discharge head according to claim 1, wherein the supporting member is in contact with the element substrate.

8. The liquid discharge head according to claim 1, wherein the flexible member has a shape protruding upward in the vertical direction in the orientation.

9. The liquid discharge head according to claim 1, wherein the flexible member has a shape protruding downward in the vertical direction when inside of the recessed portion is in a depressurized state.

10. The liquid discharge head according to claim 1, wherein a thickness of a root portion of the flexible member is thicker than a thickness of an upper portion of the flexible member.

11. The liquid discharge head according to claim 1, wherein a width of the liquid chamber gradually increases from top to bottom in the vertical direction.

12. The liquid discharge head according to claim 11, wherein as the recessed portion, two recessed portions are formed at positions opposed to the element substrate.

13. The liquid discharge head according to claim 4, wherein the space portion communicates with atmosphere.

14. The liquid discharge head according to claim 4,
wherein the space portion is connected to an atmosphere communication path communicating with atmosphere, and
wherein the atmosphere communication path bends multiple times.

15. The liquid discharge head according to claim 14,
wherein the recessed portion includes a first recessed portion and a second recessed portion,
wherein the flexible member includes a first flexible member formed on a surface forming the first recessed portion, and a second flexible member formed on a surface forming the second recessed portion,
wherein the space portion includes a first space portion formed by a back surface of the first flexible member of a surface on the first recessed portion side of the first flexible member, and a second space portion formed by a back surface of the second flexible member of a surface on the second recessed portion side of the second flexible member, and
wherein a first atmosphere communication path connected to the first space portion and a second atmosphere communication path connected to the second space portion do not intersect each other between an end portion on the first recessed portion side and an end portion on the opposite side.

16. The liquid discharge head according to claim 14,
wherein the recessed portion includes a first recessed portion and a second recessed portion,
wherein the flexible member includes a first flexible member formed on a surface forming the first recessed portion, and a second flexible member formed on a surface forming the second recessed portion,
wherein the space portion includes a first space portion formed by a back surface of the first flexible member of a surface on the first recessed portion side of the first flexible member, and a second space portion formed by a back surface of the second flexible member of a surface on the second recessed portion side of the second flexible member, and
wherein a first atmosphere communication path connected to the first space portion and a second atmosphere communication path connected to the second space portion join together between an end portion on the first recessed portion side and an end portion on the opposite side.

17. A recording device comprising:
the liquid discharge head according to claim 1; and
a suction unit configured to apply suction inside of the liquid chamber from the discharge port of the liquid discharge head.

18. A recovery method for recovering liquid discharge performance of the liquid discharge head according to claim 1 in a case where the liquid discharge performance decreases, the recovery method comprising:
connecting a cap member to the discharge port; and
applying suction to liquid in the liquid chamber from the cap member,
wherein an air bubble stored in the recessed portion moves to the liquid chamber by the flexible member of the liquid discharge head deforming to decrease a region in the recessed portion, and
wherein the air bubble having moved to the liquid chamber is suctioned by the cap member.
